(19) United States
(12) Patent Application Publication
(10) Pub. No.: US 2017/0303613 A1
(43) Pub. Date: Oct. 26, 2017

(54) WEARABLE POWER GENERATION DEVICE, WEARABLE CLOTHES CAPABLE OF GENERATING POWER AND POWER GENERATION METHOD

(71) Applicant: BOE TECHNOLOGY GROUP CO., LTD., Beijing (CN)

(72) Inventors: Wei ZHANG, Beijing (CN); Zhangfeng CAO, Beijing (CN); Bin ZHANG, Beijing (CN)

(21) Appl. No.: 15/517,326

(22) PCT Filed: Dec. 21, 2015
(86) PCT No.: PCT/CN2015/098064

§ 371 Date: Apr. 6, 2017

(30) Foreign Application Priority Data
Aug. 31, 2015 (CN) 201510549363.5

(51) Int. Cl. A41D 31/00; H02J 7/00

(52) U.S. Cl. CPC A41D 31/0066; H02J 7/007; H02J 7/0047; A41D 2600/20

(57) ABSTRACT

A wearable power generation device, wearable clothes capable of generating power, and a power generation method are provided. The wearable power generation device includes at least one magnet unit, at least one electromagnetic induction unit, and at least an energy storage unit electrically connected to the at least one electromagnetic induction unit. The magnet unit and the electromagnetic induction unit are respectively disposed to be worn on different parts of an animal body. During movement of the animal body, the magnetic flux passing through the electromagnetic induction unit is changed to generate an induction current by changing the relative position of the magnet unit and the electromagnetic unit. The energy storage unit is configured to convert the induction current generated by the electromagnetic induction unit into electric energy for storage.

### TECHNICAL FIELD

Embodiments of the present disclosure relate to a wearable power generation device, a wearable power generation garment and a power generation method.

### BACKGROUND

In recent years, with the popularity of smart phones and mini tablets, more and more people adopt smart phones for information retrieval and acquisition. But when the mobile phones and the tablets are used, people are often upset by problems, such as limited cell capacity, large power consumption of smart machines, and inconvenient charging at many times. For instance, in a situation that users need urgent communication while the mobile phones are out of power, but there is no emergency power supply.

### SUMMARY

Embodiments of the present disclosure provide a wearable power generation device, a wearable power generation garment and a power generation method.

A wearable power generation device according to an embodiment of the present disclosure, including: at least one magnet unit, at least one electromagnetic induction unit and an energy storage unit electrically connected with the at least one electromagnetic induction unit. The magnet unit and the electromagnetic induction unit are respectively designed to be worn at different positions of an animal body. Induced current is generated by a change of the magnetic flux running through the electromagnetic induction unit due to a change of relative positions of the magnet unit and the electromagnetic induction unit during movement of the animal body. The energy storage unit is configured to convert the induced current generated by the electromagnetic induction unit into electric energy for storage.

In an example of the wearable power generation device, the magnet unit and the electromagnetic induction unit are respectively disposed on the limbs and/or the trunk of the human being.

In an example of the wearable power generation device, the magnet unit includes at least one magnet, and the electromagnetic induction unit includes a single closed loop or a plurality of parallel closed loops.

In an example of the wearable power generation device, the magnet is a flexible magnet.

In an example of the wearable power generation device, a surface magnetic field strength of the magnet unit is greater than or equal to 0.3 T.

In an example of the wearable power generation device, further including a display unit, the display unit being configured to display a value of the electric energy stored by the energy storage unit.

A wearable power generation garment according to an embodiment of the present disclosure, including: a garment body; at least one magnet unit; at least one electromagnetic induction unit; and an energy storage unit electrically connected with the at least one electromagnetic induction unit. The magnet unit and the electromagnetic induction unit are respectively fixed at different positions of the body. Induced current is generated by a change of the magnetic flux running through the electromagnetic induction unit due to a change of relative positions of the magnet unit and the electromagnetic induction unit during a movement of an animal body wearing the power generation garment. The energy storage unit is configured to convert the induced current generated by the electromagnetic induction unit into electrical energy for storage.

In an example of the wearable power generation garment, the body is a pair of trousers. The magnet unit is disposed on one trouser leg of the trousers; and the electromagnetic induction unit is disposed on the other trouser leg.

In an example of the wearable power generation garment, the body is a coat with sleeves. The magnet unit is disposed on one sleeve of the coat, and the electromagnetic induction unit is disposed on the other sleeve; or the magnet unit is disposed on one of the sleeve and the body of the coat, and the electromagnetic induction unit is disposed on the other of the sleeve and the body.

In an example of the wearable power generation garment, both the magnet unit and the electromagnetic induction unit are disposed on insides of the trouser legs, so that the magnet unit and the electromagnetic induction unit can be oppositely arranged.

In an example of the wearable power generation garment, the magnet unit is fixed on a side surface of the body of the coat, and the electromagnetic induction unit is fixed at a relative position on an inside of the sleeves of the coat, so that the magnet unit and the electromagnetic induction unit is oppositely arranged; or the electromagnetic induction unit is fixed on a side surface of the body of the coat, and the magnet unit is fixed at a corresponding position on an inside of the sleeves of the coat, so that the magnet unit and the electromagnetic induction unit is oppositely arranged.

In an example of the wearable power generation garment, the magnet unit is fixed on the body by sewing, bonding or binding; and/or the electromagnetic induction unit is fixed on the body by sewing, bonding or binding.

A power generation method according to an embodiment of the present disclosure, including: wearing the wearable power generation device or the wearable power generation garment on an animal body; and generating electric energy during the movement of the animal body.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 is a schematic structural view of a wearable power generation device provided by an embodiment of the present disclosure;

FIGS. 2a to 2c are respectively schematic structural views of wearable power generation devices provided by embodiments of the present disclosure;

FIGS. 3a to 3d are respectively schematic diagram illustrating positions of the wearable power generation device provided by embodiments of the present disclosure;

FIG. 4 is a schematic structural view of a wearable power generation device provided by an embodiment of the present disclosure;

FIGS. 5a and 5b are respectively flow diagrams of induced currents of the wearable power generation device provided by embodiments of the present disclosure;

FIG. 6a is a graph of induced electromotive force generated by a closed loop during the reciprocating motion of the closed loop and a permanent magnet;

FIG. 6b is a graph of the induced current generated by the closed loop during the reciprocating motion of the closed loop and the permanent magnet, running through a diode D1;

FIG. 6c is a graph of the induced current generated by the closed loop during the reciprocating motion of the closed loop and the permanent magnet, running through a diode D2;

FIG. 6d is a graph of the induced current generated by the closed loop during the reciprocating motion of the closed loop and the permanent magnet, running through an energy storage module; and

FIGS. 7a and 7b are respectively schematic structural views of a wearable power generation garment provided by embodiments of the present disclosure.

### DETAILED DESCRIPTION

Technical solutions according to the embodiments of the present disclosure will be described clearly and fully as below in conjunction with the accompanying drawings of embodiments of the present disclosure. It is apparent that the described embodiments are just a part but not all of the embodiments of the disclosure. Based on the described embodiments herein, a person of ordinary skill in the art can obtain other embodiment(s), without any creative work, which shall be within the scope of the present disclosure.

Unless otherwise defined, all the technical and scientific terms used herein have the same meanings as commonly understood by a person of ordinary skill in the art to which the present disclosure belongs. The terms, such as “first,” “second,” or the like, which are used in the description and the claims of the present disclosure, are not intended to indicate any sequence, amount or importance, but for distinguishing various components. Also, the terms, such as “a,” “an,” “the,” or the like, are not intended to limit the amount, but may be for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

In daily life, we often encounter a situation that an urgent communication is required while the mobile phone is out of power but no emergency power supply may be used. In this case, we hope there is a power generation device which can be charged readily and is portable. Embodiments of the present disclosure provide a wearable power generation device, a wearable power generation garment and a power generation method.

With reference to the accompanying drawings, detailed description will be given below to examples of the wearable power generation device, the wearable power generation garment and the power generation method, provided by embodiments of the present disclosure.

The embodiment of the present disclosure provides a wearable power generation device, which, as shown in FIG. 1, includes: at least one magnet unit 1 (only one is shown in FIG. 1), at least one electromagnetic induction unit 2 (only one is shown in FIG. 1) and an energy storage unit 3 electrically connected with the at least one electromagnetic induction unit 2.

The magnet unit 1 and the electromagnetic induction unit 2 are respectively disposed at different positions of an animal body. Induced current is generated by the change of the magnetic flux running through the electromagnetic induction unit 2 due to the change of relative positions of the magnet unit 1 and the electromagnetic induction unit 2 during the movement of the animal body.

The energy storage unit 3 is configured to convert the induced current generated by the electromagnetic induction unit 2 into electric energy for storage.

The wearable power generation device provided by the embodiment of the present disclosure includes: at least one magnet unit, at least one electromagnetic induction unit and an energy storage unit electrically connected with the at least one electromagnetic induction unit. The magnet unit and the electromagnetic induction unit are respectively disposed at different positions of an animal body. Induced current is generated by the change of the magnetic flux running through the electromagnetic induction unit due to the change of relative positions of the magnet unit and the electromagnetic induction unit during the movement of the animal body. The energy storage unit is configured to convert the induced current generated by the electromagnetic induction unit into electric energy for storage. The power generation device applies the law of electromagnetic induction, generates electricity by the generation of the induced current due to the change of the magnetic flux running through the electromagnetic induction unit by the movement of the animal body, and stores the electric energy for later use. The power generation device has advantages of simple structure, portable, convenient, environment-friendly, noise-free and low cost.

It is noted that, in the wearable power generation device provided by the embodiment of the present disclosure, the magnet unit and the electromagnetic induction unit are respectively designed to be worn at different positions of an animal body. The animal may be a cat and a dog, and it may also be a human being, but the embodiments of the present disclosure are not limited thereto.

Detailed description will be given below to the wearable power generation device provided by an embodiment of the present disclosure by taking an instance that the animal body is a human being as an example.

In an example, in the wearable power generation device provided by the embodiment of the present disclosure, the magnet unit and the electromagnetic induction unit are respectively designed to be worn on the limbs and/or the trunk of a human being. The limbs may be arms, hands, legs or feet, but the embodiments of the present disclosure are not limited thereto.

In an example, in the wearable power generation device provided by the embodiment of the present disclosure, when a plurality of electromagnetic induction units are arranged, it is possible that each electromagnetic induction unit is electrically connected with a single energy storage unit, or a plurality of electromagnetic induction units correspond to a single energy storage unit. But the embodiments of the present disclosure are not limited thereto.

In an example, in the wearable power generation device provided by the embodiment of the present disclosure, when a plurality of the electromagnetic induction units are provided, the plurality of electromagnetic induction units correspond to a single energy storage unit. In this way, it can accelerate the energy storage speed of the energy storage unit, and simplify the structure and reduce the cost.

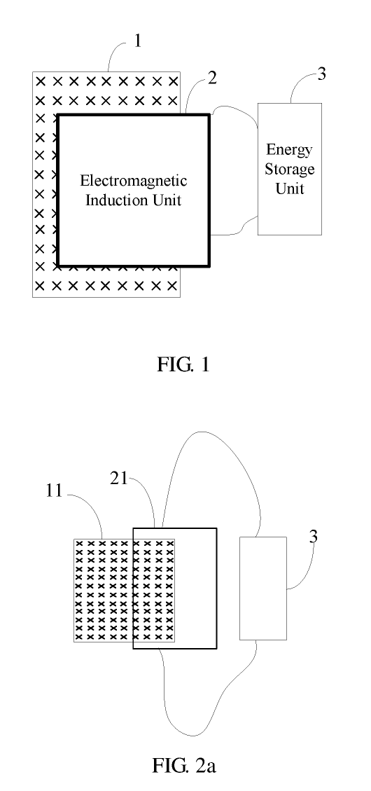

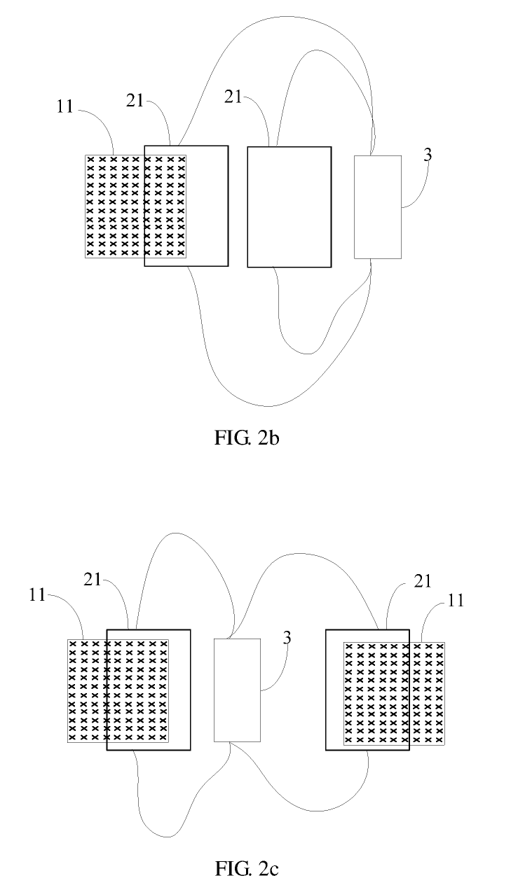

In an example, in the wearable power generation device provided by the embodiment of the present disclosure, as shown in FIGS. 2a to 2c, the magnet unit 1 includes at least one magnet 11, and the electromagnetic induction unit 2 includes a single closed loop 21 or a plurality of closed loops 21 in parallel. But the embodiments of the present disclosure are not limited thereto.

In an example, in the wearable power generation device provided by the embodiment of the present disclosure, the magnet is a permanent magnet.

In an example, in the wearable power generation device provided by the embodiment of the present disclosure, the area encircled by the closed loop is set to be equal to the opposite area of the permanent magnet, which can avoid the case of unchanged magnetic flux during the relative motion of the permanent magnet and the closed loop.

In an example, in the wearable power generation device provided by the embodiment of the present disclosure, the magnet is a flexible magnet, so that the wearable power generation device can be easy to wear, and it also can allow the carrier to be more comfortable.

In the wearable power generation device provided by the embodiment of the present disclosure, the more the number of the parallel closed loops in the electromagnetic induction unit is, the more the generated induced electric energy is. But too numerous closed loops may affect the movement of the carrier.

Similarly, in the wearable power generation device provided by the embodiment of the present disclosure, the larger the area encircled by the closed loop and the opposite area of the magnet are, the more the generated induced electric energy is. But too larger opposite area may also affect the movement of the carrier.

In the wearable power generation device provided by the embodiment of the present disclosure, under the same condition, the closer the distance between the electromagnetic unit and the electromagnetic induction unit is, the larger the generated induced electromotive force is. Therefore, in an example, the electromagnetic unit and the electromagnetic induction unit are set to be worn at positions of the animal body as close as possible.

Detailed description will be given below to the assembled positions of the magnet unit and the electromagnetic induction unit in the present disclosure with reference to the exemplary embodiments. It is noted that the embodiments are used for better understanding of the present disclosure, but the embodiments of the present disclosure are not limited thereto.

### First Embodiment

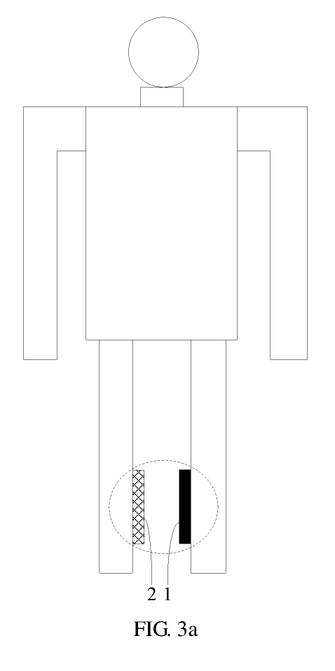

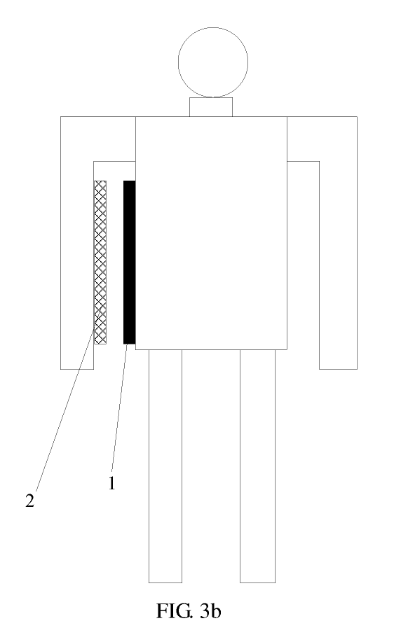

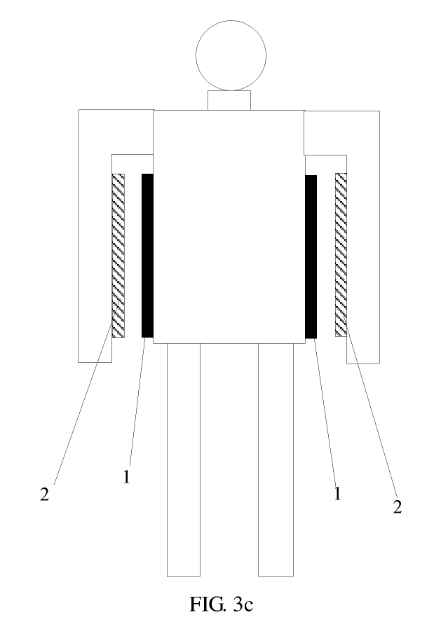

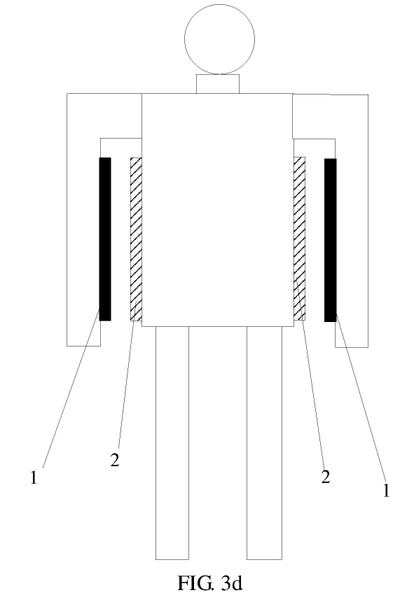

In the wearable power generation device provided by the embodiment of the present disclosure, as shown in FIG. 3a, the magnet unit 1 and the electromagnetic induction unit 2 are respectively designed to be worn at corresponding positions on the inside of two legs of the human body.

In an example, the magnet unit 1 may be designed to be worn on a left leg and the electromagnetic induction unit 2 may be designed to be worn on a right leg, or the magnet unit 1 may be designed to be worn on the right leg and the electromagnetic induction unit 2 may be designed to be worn on the left leg. But the embodiments of the present disclosure are not limited thereto.

In this way, when the human body is moving around, the relative positions of the two legs change, so that the relative positions of the magnet unit and the electromagnetic induction unit change, so that induced current is generated due to the change of the magnetic flux running through the electromagnetic induction unit.

### Second Embodiment

In the wearable power generation device provided by the embodiment of the present disclosure, as shown in FIG. 3b, the magnet unit 1 and the electromagnetic induction unit 2 are respectively designed to be worn on the inside of the arm of the human body and the trunk at a relative position.

In an example, the magnet unit 1 may be designed to be worn on the inside of a left arm (or a right arm), and the electromagnetic induction unit 2 may be designed to be worn at a relative position of the left trunk (or the right trunk); Or, in another example, the electromagnetic induction unit 2 is designed to be worn on the inside of the left arm (or the right arm), and the magnet unit 2 is designed to be worn at the relative position of the left trunk (or the right trunk). But the embodiments of the present disclosure are not limited thereto.

In this way, when the arm of the human body swings back and forth, the relative positions of the magnet unit and the electromagnetic induction unit may change, so that induced current is generated due to the change of the magnetic flux running through the electromagnetic induction unit.

### Third Embodiment

In the wearable power generation device provided by the embodiment of the present disclosure, as shown in FIG. 3c, the magnet units 1 are respectively designed to be worn on both sides of the trunk of the human body, and the electromagnetic induction units 2 are respectively designed to be worn at relative positions on the inside of the arms of the human body; or as shown in FIG. 3d, the electromagnetic induction units 2 are respectively designed to be worn on both sides of the trunk of the human body, and the magnet units 1 are respectively designed to be worn at the relative positions on the inside of the arms of the human body.

In this way, when the arms of the human body swing back and forth, the relative positions of the magnet units and the electromagnetic induction units may change, so that induced current is generated due to the change of the magnetic flux running through the electromagnetic induction units.

In an example, in the wearable power generation device provided by the embodiment of the present disclosure, the energy storage unit is designed to be worn at a position near a position at which the electromagnetic induction unit electrically connected with the energy storage unit is fixed. In this way, the length of a lead between the energy storage unit and the electromagnetic induction unit can be reduced, and the power consumption on the lead can be reduced. In another example, the lead between the energy storage unit and the electromagnetic induction unit may be lengthened, which is conducive to the placing of the energy storage unit.

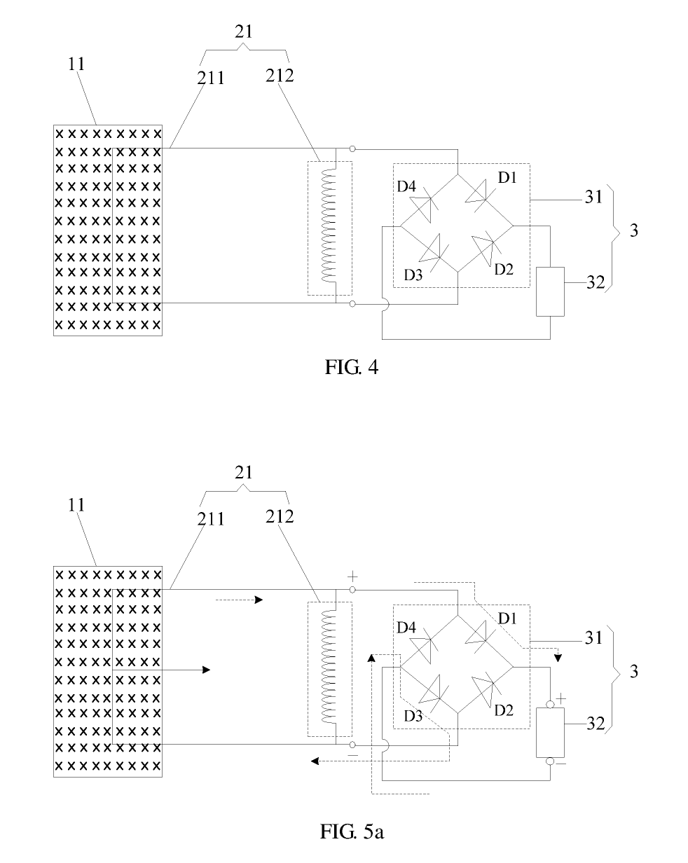

In an example, in the wearable power generation device provided by the embodiment of the present disclosure, as shown in FIG. 4, the energy storage unit 3 substantially includes AC-to-DC (an alternating current to direct current) module 31 and an energy storage module 32. Two input ends of the AC-to-DC module 31 are respectively connected with output ends of the electromagnetic induction units 2, so as to convert the induced current generated on the electromagnetic induction units 2 into DC and output the DC to the energy storage module 32 for storage.

In an example, in the wearable power generation device provided by the embodiment of the present disclosure, as shown in FIG. 4, the AC-to-DC module 31 includes a bridge rectifier circuit.

Two input ends of the bridge rectifier circuit are respectively connected with the output ends of the electromagnetic induction units 2, and two output ends are respectively connected with both ends of the energy storage module 32.

In an example, the structure of the bridge rectifier circuit is the same as the one in the art. As shown in FIG. 4, it includes 4 diodes (D1, D2, D3 and D4) substantially, but the embodiments of the present disclosure are not limited thereto.

In the wearable power generation device provided by the embodiment of the present disclosure, the energy storage module is preferably a small-size supercapacitor (within 2.7 volts), for example.

In an example, in the wearable power generation device provided by the embodiment of the present disclosure, as shown in FIG. 4, a closed loop 21 substantially includes a lead 211 and a step-up coil 212, and induced voltage generated on the lead 211 is stepped up by the step-up coil 212 and outputted to the bridge rectifier circuit.

In an example, in the wearable power generation device provided by the embodiment of the present disclosure, the surface magnetic field strength of the magnet unit is greater than or equal to 0.3 T.

In an example, the wearable power generation device provided by the embodiment of the present disclosure also includes a display unit.

The display unit is configured to display the value of the electric energy stored by the energy storage unit, so that the user can conveniently check the charging condition.

Description will be given below to the charging condition of a portable charging device in the embodiment of the present disclosure by taking the structure as shown in FIG. 4 as an example.

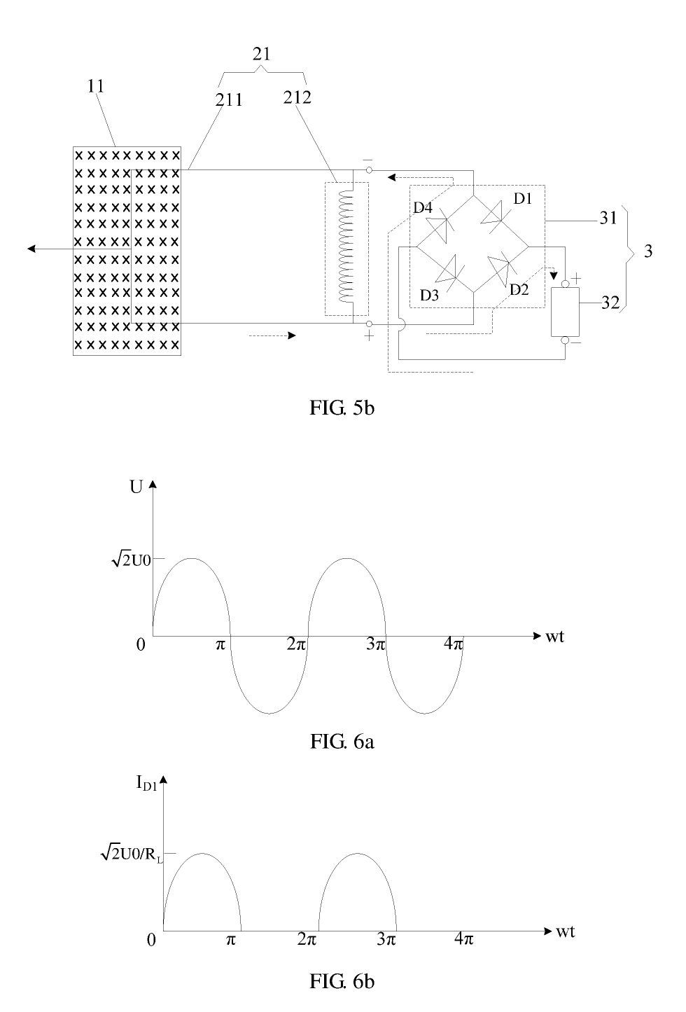

If the lead 211 moves to the right relative to the magnet 11, as shown in FIG. 5a, the flow direction of corresponding induced current is as shown by dotted arrows in the figure; if the lead 211 moves to the left relative to the magnet 11, as shown in FIG. 5b, the flow direction of corresponding induced current is as shown by dotted arrows in the figure.

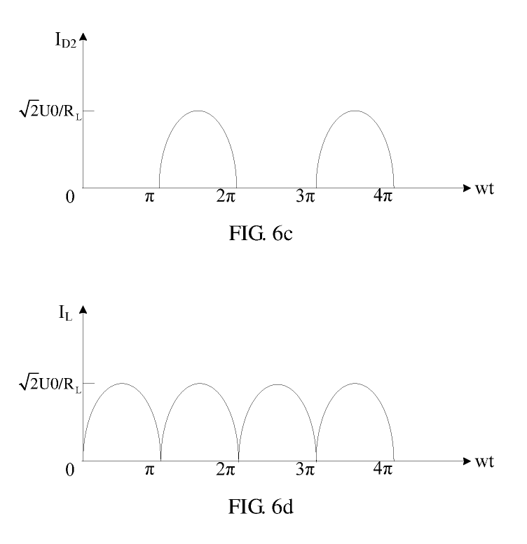

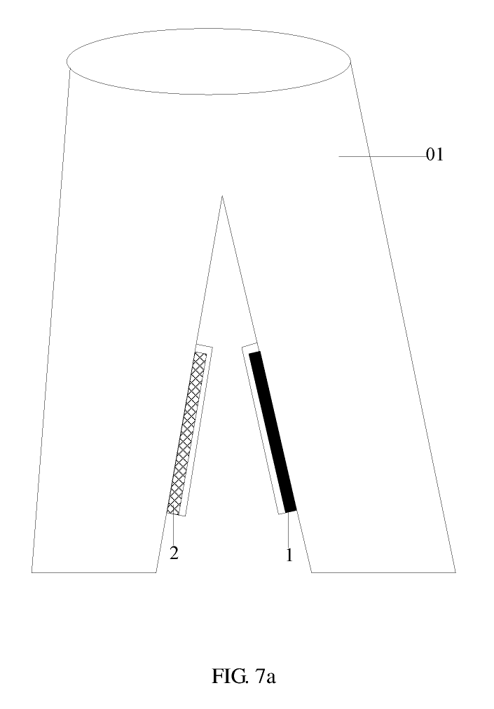

If the reciprocating motion of the closed loop 21 and the magnet 11 occurs during the movement of the human body, the current produced on the closed loop 21 is sinusoidal alternating current, and a graph of corresponding induced electromotive force U along with the swing amplitude wt is as shown in FIG. 6a. Supposing that the equivalent resistance of the energy storage module 32 is R_{L}, when the lead 211 moves to the right relative to the magnet 11, the induced current flows across the diode D1 in the bridge rectifier circuit and enters the energy storage module 32, and a graph of the current I_{D1} flowing across the diode D1 along with the swing amplitude wt is as shown in FIG. 6b. When the lead 211 moves to the left relative to the magnet 11, the induced current flows across the diode D2 in the bridge rectifier circuit and enters the energy storage module 32, and a graph of the current I_{D2} flowing across the diode D2 along with the swing amplitude wt is as shown in FIG. 6c. Correspondingly, during the reciprocating motion of the closed loop 21 and the magnet 11, the graph of the current I_{L} flowing across the energy storage module 32 along with the swing amplitude wt is as shown in FIG. 6d.

Supposing that the magnetic field strength B of the magnet 11 is 0.3 T and the length L of the lead 211 in cutting a magnetic field line is 0.4 m, the speed of the relative motion of the closed loop 21 and the magnet 11 is 1 m/s. According to the formula of the induced electromotive force E=BLV, the maximum induced electromotive force Uₘₐₓ=E=BLV=0.3 T×0.4 m×1 m/s=0.12V, and the effective electromotive force U₀=Uₘₐₓ/\sqrt{2}. The measured resistance of a copper wire with the length of 1 meter and the cross-sectional area of 1 square millimeter is R≈0.00167852; the total length of the closed loop is about 1 m; if energy loss is not considered, the charging power of a single closed loop in cutting the magnetic field line is p=U²/R=(0.12/\sqrt{2})²/0.001678=4.29 W; and finally, if the loss of the step-up coils and the diodes is omitted, the effective charging power of the single closed loop is p₀=0.1 p=0.429 W.

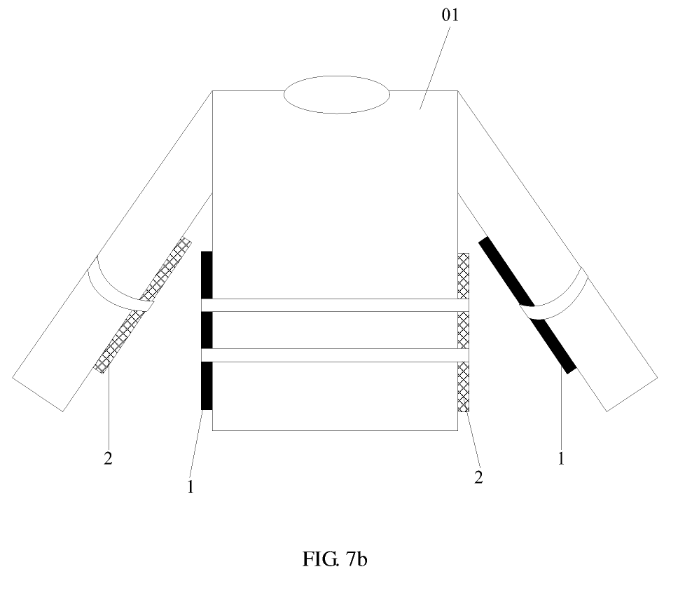

Based on the same concept, an embodiment of the present disclosure also provides a wearable power generation garment, which, as shown in FIGS. 7a and 7b, includes a garment body 01, and it also includes: at least one magnet unit 1, at least one electromagnetic induction unit 2 and an energy storage unit 3 electrically connected with the at least one electromagnetic induction unit 2.

The magnet unit 1 and the electromagnetic induction unit 2 are respectively fixed at different positions of the body 01. Induced current is generated by the change of the magnetic flux running through the electromagnetic induction unit 2 due to the change of relative positions of the magnet unit 1 and the electromagnetic induction unit 2 during the movement of an animal body wearing the power generation garment.

The energy storage unit 3 is configured to convert the induced current generated by the electromagnetic induction unit 2 into electric energy for storage.

The wearable power generation garment provided by the embodiment of the present disclosure applies the law of electromagnetic induction, generates electricity by the generation of the induced current due to the change of the magnetic flux running through the electromagnetic induction unit by the change of the relative positions of the magnet unit and the electromagnetic induction unit by the movement of the animal body wearing the power generation garment, and stores the electric energy for later use. The power generation garment has advantages of simple structure, portable, convenient, environment-friendly, noise-free and low cost.

In an example, in the wearable power generation garment provided by the embodiment of the present disclosure, as shown in FIG. 7a, the body 01 is a pair of trousers; the magnet unit 1 is disposed on one trouser leg of the trousers; and the electromagnetic induction unit 2 is disposed on the other trouser leg.

In an example, in the wearable power generation garment provided by the embodiment of the present disclosure, as shown in FIG. 7a, both the magnet unit 1 and the electromagnetic induction unit 2 are disposed on the inside of the trouser legs, so that the magnet unit 1 and the electromagnetic induction unit 2 can be oppositely arranged.

In another example, in the wearable power generation garment provided by the embodiment of the present disclosure, as shown in FIG. 7b, the body 01 is a coat with sleeves.

The magnet unit 1 is disposed on one sleeve of the coat, and the magnetic induction unit 2 is disposed on the other sleeve, or the magnet unit 1 is disposed on one of the sleeve and the body of the coat, and the electromagnetic induction unit 2 is disposed on the other of the sleeve and the body. But the embodiments of the present disclosure are not limited thereto.

In an example, in the wearable power generation garment provided by the embodiment of the present disclosure, as shown in FIG. 7b, the magnet unit 1 is fixed on a side surface of the body of the coat, and the electromagnetic induction unit 2 is fixed at a relative position on the inside of a sleeve of the coat, so that the magnet unit 1 and the electromagnetic induction unit 2 can be oppositely arranged; or in another example, the electromagnetic induction unit 2 is fixed on a side surface of the body of the coat and the magnet unit 1 is fixed at a relative position on the inside of a sleeve of the coat, so that the magnet unit 1 and the electromagnetic induction unit 2 can be oppositely arranged. But the embodiments of the present disclosure are not limited thereto.

In an example, in the wearable power generation garment provided by the embodiment of the present disclosure, the magnet unit may be fixed on the body by sewing, bonding or binding.

In an example, in the wearable power generation garment provided by the embodiment of the present disclosure, the electromagnetic induction unit may also be fixed on the body by sewing, bonding or binding. But the embodiments of the present disclosure are not limited thereto.

In an example, in the wearable power generation garment provided by the embodiment of the present disclosure, both the magnet unit and the electromagnetic induction unit are fixed on the body by sewing, bonding or binding.

In an example, in the wearable power generation garment provided by the embodiment of the present disclosure, the magnet unit includes at least one magnet, and the electromagnetic induction unit includes one closed loop or a plurality of parallel closed loops. But the embodiments of the present disclosure are not limited thereto.

In an example, in the wearable power generation garment provided by the embodiment of the present disclosure, as shown in FIG. 7a, both the magnet unit 1 and the electromagnetic induction unit 2 are fixed on the body 01 by sewing, namely it is equivalent that the magnet unit 1 and the electromagnetic induction unit 2 are sewn on two pieces of cloth. In another example, as shown in FIG. 7b, both the magnet unit 1 and the electromagnetic induction unit 2 are fixed on the body 01 by binding.

In an example, in the wearable power generation garment provided by the embodiment of the present disclosure, the magnet is a permanent magnet.

In an example, in the wearable power generation garment provided by the embodiment of the present disclosure, the area encircled by the closed loop is set to be equal to the opposite area of the permanent magnet, which can avoid the situation of unchanged magnetic flux during the relative motion of the permanent magnet and the closed loop.

In an example, in the wearable power generation garment provided by the embodiment of the present disclosure, the magnet is a flexible magnet, so that the wearable power generation garment can be easy to fix, and the wearer can be more comfortable.

In the wearable power generation garment provided by the embodiment of the present disclosure, the more the number of the parallel closed loops in the electromagnetic induction unit is, the more the generated induced electric energy is. But too numerous closed loops may affect the movement of the carrier.

Similarly, in the wearable power generation garment provided by the embodiment of the present disclosure, the larger the area encircled by the closed loop and the opposite area of the magnet is, the more the generated induced electric energy is. But too larger opposite area may affect the movement of the carrier.

In an example, in the wearable power generation garment provided by the embodiment of the present disclosure, as shown in FIG. 4, the energy storage unit 3 substantially includes an AC-to-DC module 31 and an energy storage module 32. Two input ends of the AC-to-DC module 31 are respectively connected with output ends of the electromagnetic induction units 2, so as to convert the induced current generated on the electromagnetic induction units 2 into DC and output the DC to the energy storage module 32 for storage.

In an example, in the wearable power generation garment provided by the embodiment of the present disclosure, as shown in FIG. 4, the AC-to-DC module 31 includes a bridge rectifier circuit.

Two input ends of the bridge rectifier circuit are respectively connected with the output ends of the electromagnetic induction units 2, and two output ends are respectively connected with both ends of the energy storage module 32.

In an example, the structure of the bridge rectifier circuit is the same as the one in the art. As shown in FIG. 4, it substantially includes 4 diodes (D1, D2, D3 and D4), but the embodiments of the present disclosure are not limited thereto.

In an example, in the wearable power generation garment provided by the embodiment of the present disclosure, the energy storage module is, for instance, a small-size supercapacitor (within 2.7 volts).

In an example, in the wearable power generation garment provided by the embodiment of the present disclosure, as shown in FIG. 4, a closed loop 21 substantially includes a lead 211 and a step-up coil 212, and induced voltage generated on the lead 211 is stepped up by the step-up coil 212 and outputted to the bridge rectifier circuit.

In an example, in the wearable power generation garment provided by the embodiment of the present disclosure, the surface magnetic field strength of the magnet unit is greater than or equal to 0.3 T.

In an example, the wearable power generation garment provided by the embodiment of the present disclosure also includes a display unit. The display unit is configured to display the value of the electric energy stored by the energy storage unit, so that the user can conveniently check the charging condition.

Based on the same concept, the embodiment of the present disclosure also provides a power generation method, including: wearing any of the wearable power generation devices provided by the embodiments of the present disclosure or any of the wearable power generation garments provided by the embodiments of the present disclosure on an animal body, and generating electric energy during the movement of the animal body.

In the wearable power generation device, the wearable power generation garment and the power generation method, provided by the embodiments of the present disclosure, the wearable power generation device includes at least one magnet unit, at least one electromagnetic induction unit and an energy storage unit electrically connected with the at least one electromagnetic induction unit. The magnet unit and the electromagnetic induction unit are respectively disposed at different positions of an animal body. Induced current is generated by the change of the magnetic flux running through the electromagnetic induction unit due to the change of relative positions of the magnet unit and the electromagnetic induction unit during the movement of the animal body. The energy storage unit is configured to convert the induced current generated by the electromagnetic induction unit into electric energy for storage. The power generation device applies the law of electromagnetic induction, generates electricity by the generation of the induced current due to the change of the magnetic flux running through the electromagnetic induction unit by the movement of the animal body, and stores the electric energy for later use. The power generation device has advantages of simple structure, portable, convenient, environment-friendly, noise-free and low cost.

The described above are only exemplary embodiments of the present disclosure, and the present disclosure is not intended to be limited thereto. For one of ordinary skill in the art, various changes and alternations may be made without departing from the technical scope of the present disclosure, and all of these changes and alternations shall fall within the scope of the present disclosure.

The application claims priority to the Chinese patent application No. 201510549363.5 filed on Aug. 31, 2015 and entitled “Wearable Power Generation Device, Wearable Power Generation Garment and Power Generation Method,” which is incorporated herein by reference in its entirety.

1. A wearable power generation device, comprising: at least one magnet unit, at least one electromagnetic induction unit and an energy storage unit electrically connected with the at least one electromagnetic induction unit, wherein
the magnet unit and the electromagnetic induction unit are respectively designed to be worn at different positions of an animal body; induced current is generated by a change of the magnetic flux running through the electromagnetic induction unit due to a change of relative positions of the magnet unit and the electromagnetic induction unit during movement of the animal body; and
the energy storage unit is configured to convert the induced current generated by the electromagnetic induction unit into electric energy for storage.

2. The wearable power generation device according to claim 1, wherein
the magnet unit and the electromagnetic induction unit are respectively disposed on the limbs and/or the trunk of the human being.

3. The wearable power generation device according to claim 1, wherein the magnet unit includes at least one magnet, and the electromagnetic induction unit includes a single closed loop or a plurality of parallel closed loops.

4. The wearable power generation device according to claim 3, wherein the magnet is a flexible magnet.

5. The wearable power generation device according to claim 1, wherein a surface magnetic field strength of the magnet unit is greater than or equal to 0.3 T.

6. The wearable power generation device according to claim 1, further comprising a display unit, wherein the display unit is configured to display a value of the electric energy stored by the energy storage unit.

7. A wearable power generation garment, comprising:
a garment body;
at least one magnet unit;
at least one electromagnetic induction unit; and
an energy storage unit electrically connected with the at least one electromagnetic induction unit, wherein
the magnet unit and the electromagnetic induction unit are respectively fixed at different positions of the body; induced current is generated by a change of the magnetic flux running through the electromagnetic induction unit due to a change of relative positions of the magnet unit and the electromagnetic induction unit during a movement of an animal body wearing the power generation garment; and
the energy storage unit is configured to convert the induced current generated by the electromagnetic induction unit into electrical energy for storage.

8. The wearable power generation garment according to claim 7, wherein the body is a pair of trousers; the magnet unit is disposed on one trouser leg of the trousers; and the electromagnetic induction unit is disposed on the other trouser leg.

9. The wearable power generation garment according to claim 7, wherein the body is a coat with sleeves, in which
the magnet unit is disposed on one sleeve of the coat and the electromagnetic induction unit is disposed on the other sleeve; or the magnet unit is disposed on one of the sleeve and the body of the coat, and the electromagnetic induction unit is disposed on the other of the sleeve and the body.

10. The wearable power generation garment according to claim 8, wherein
both the magnet unit and the electromagnetic induction unit are disposed on insides of the trouser legs, so that the magnet unit and the electromagnetic induction unit can be oppositely arranged.

11. The wearable power generation garment according to claim 9, wherein
the magnet unit is fixed on a side surface of the body of the coat, and the electromagnetic induction unit is fixed at a relative position on an inside of the sleeves of the coat, so that the magnet unit and the electromagnetic induction unit is oppositely arranged; or
the electromagnetic induction unit is fixed on a side surface of the body of the coat, and the magnet unit is fixed at a relative position on an inside of the sleeves of the coat, so that the magnet unit and the electromagnetic induction unit is oppositely arranged.

12. The wearable power generation garment according to claim 7, wherein
unit is fixed on the body by sewing, bonding or binding.

13. A power generation method, comprising:
wearing the wearable power generation device according to claim 1 on an animal body; and
generating electric energy during the movement of the animal body.

14. A power generation method, comprising:
wearing the wearable power generation garment according to claim 7 on an animal body; and
generating electric energy during the movement of the animal body.

15. The wearable power generation garment according to claim 7, wherein the electromagnetic induction unit is fixed on the body by sewing, bonding or binding.

16. The wearable power generation garment according to claim 12, wherein the electromagnetic induction unit is fixed on the body by sewing, bonding or binding.

17. The wearable power generation device according to claim 2, wherein the magnet unit includes at least one magnet, and the electromagnetic induction unit includes a single closed loop or a plurality of parallel closed loops.

18. The wearable power generation device according to claim 2, further comprising a display unit, wherein the display unit is configured to display a value of the electric energy stored by the energy storage unit.

19. The wearable power generation device according to claim 2, wherein a surface magnetic field strength of the magnet unit is greater than or equal to 0.3 T.

20. The wearable power generation device according to claim 19, further comprising a display unit, wherein the display unit is configured to display a value of the electric energy stored by the energy storage unit.
